(19) United States
(12) Patent Application Publication
(10) Pub. No.: US 2013/0117694 A1
(43) Pub. Date: May 9, 2013

(54) POLLING SYSTEMS AND METHODS

(71) Applicants: Ian P. SHIELDS, Derwood, MD (US); Dennis Shields, Derwood, MD (US)

(72) Inventors: Ian P. SHIELDS, Derwood, MD (US); Dennis Shields, Derwood, MD (US)

(73) Assignee: Cooperative Software Systems, LLC, Derwood, MD (US)

(21) Appl. No.: 13/348,948

(22) Filed: Jan. 12, 2012

Related U.S. Application Data
(60) Provisional application No. 61/557,727, filed on Nov. 9, 2011.

(51) Int. Cl. G06F 3/01

(52) U.S. Cl. 715/760

(57) ABSTRACT

Computer systems and computer-implemented methods for assisting individuals in conducting, participating in, and viewing polls, while minimizing statistical bias and maximizing poll accessibility and poll viewing functionalities, are disclosed. A computer-implemented polling method is implemented on a website. The polling method includes registering a user account, facilitating the creation of a poll, facilitating a review of the poll, facilitating user participation in the poll, and facilitating viewing results of the poll.

### RELATED APPLICATIONS

The present invention claims priority under 35 U.S.C. §120 to U.S. Provisional Patent Application No. 61/557,727 filed on Nov. 9, 2011, the disclosure of which is incorporated by reference herein in its entirety.

### BACKGROUND

Polling can provide useful sociological data, with scientific applications in various areas, such as psychology and political science, as well as business applications in numerous industries, such as health care and human resources management.

Conventional polling systems are inefficient. Oftentimes, poll participants are required to provide identical user information for numerous polls. Furthermore, conventional polling systems provide limited accessibility and viewing functionalities. Conventional polling systems oftentimes neither provide immediate access to the full results of a poll displayed on a topographical map, nor allow polls to be generated by the poll participants. Moreover, poll participants themselves often are not provided access to poll results.

### SUMMARY

An exemplary embodiment of a computer-implemented polling method may be implemented on a website. The polling method may include registering a user account, facilitating the creation of a poll, facilitating a review of the poll, facilitating user participation in the poll, and facilitating viewing results of the poll.

### BRIEF DESCRIPTION OF THE FIGURES

The present embodiments are illustrated by way of example and not limitation in the figures of the accompanying drawings, in which like references indicate similar elements and in which:

FIG. 1 illustrates an exemplary embodiment of a computer-implemented polling method,

FIG. 2 illustrates an exemplary embodiment of a method of registering a user account,

FIG. 3 illustrates an exemplary embodiment of a method of facilitating the creation of a poll,

FIG. 4 illustrates an exemplary embodiment of a method of facilitating a review of a poll,

FIG. 5 illustrates an exemplary embodiment of a method of facilitating user participation in a poll, and

FIGS. 6a, 6b and 6c illustrate an exemplary embodiment of a system for displaying poll results.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, a discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Embodiments disclosed herein describe computer systems and computer-implemented methods for assisting individuals in conducting, participating in, and viewing polls, while minimizing statistical bias and influence and maximizing poll accessibility and poll viewing functionalities. Individuals or organizations, such as political parties and businesses, may conduct, participate in, and/or view polls to monitor public opinion, or opinions in a local environment.

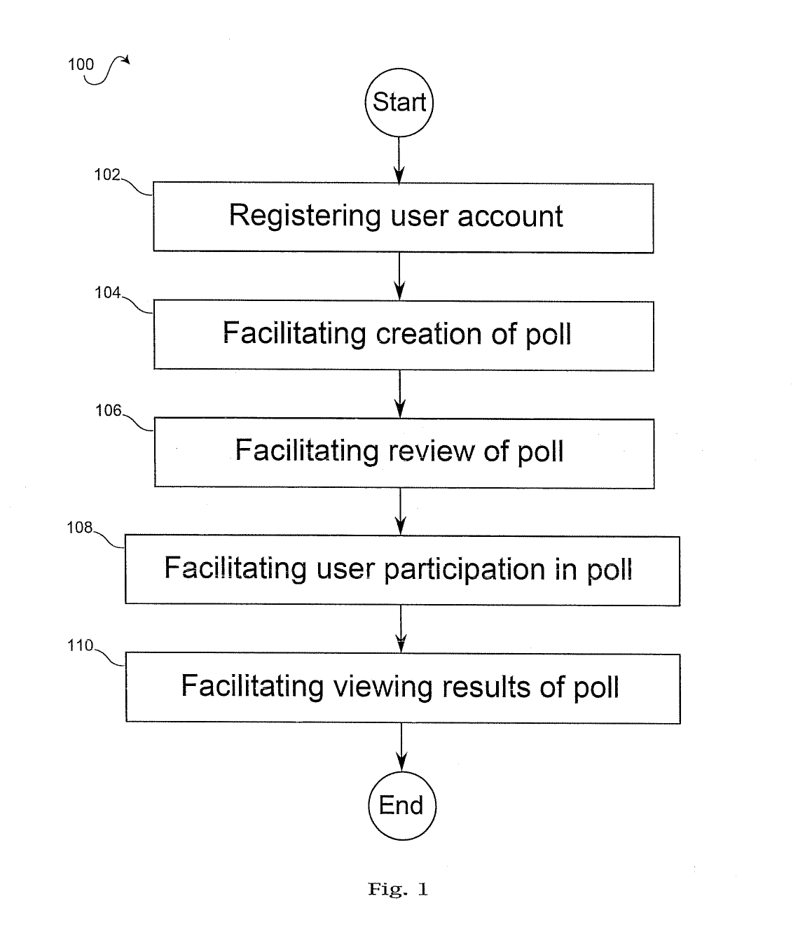

FIG. 1 shows an exemplary embodiment 100 of a computer-implemented polling method. The polling method may be implemented on a website server, which may include a public, private, or semi-private website accessible through a client end, an administrator end, and a server end. The polling method may include registering a user account, facilitating the creation of a poll, facilitating a review of the poll, facilitating user participation in the poll, and facilitating viewing results of the poll. At step 102 of the polling method, a user may create a user account at a client end of the website. At step 104 of the polling method, a user may create a poll at a client end of the website. At step 106 of the polling method, an administrator may review the poll at an administrative end of the website. At step 108 of the polling method, a user may participate in the poll. At step 110 of the polling method, a user may view poll results.

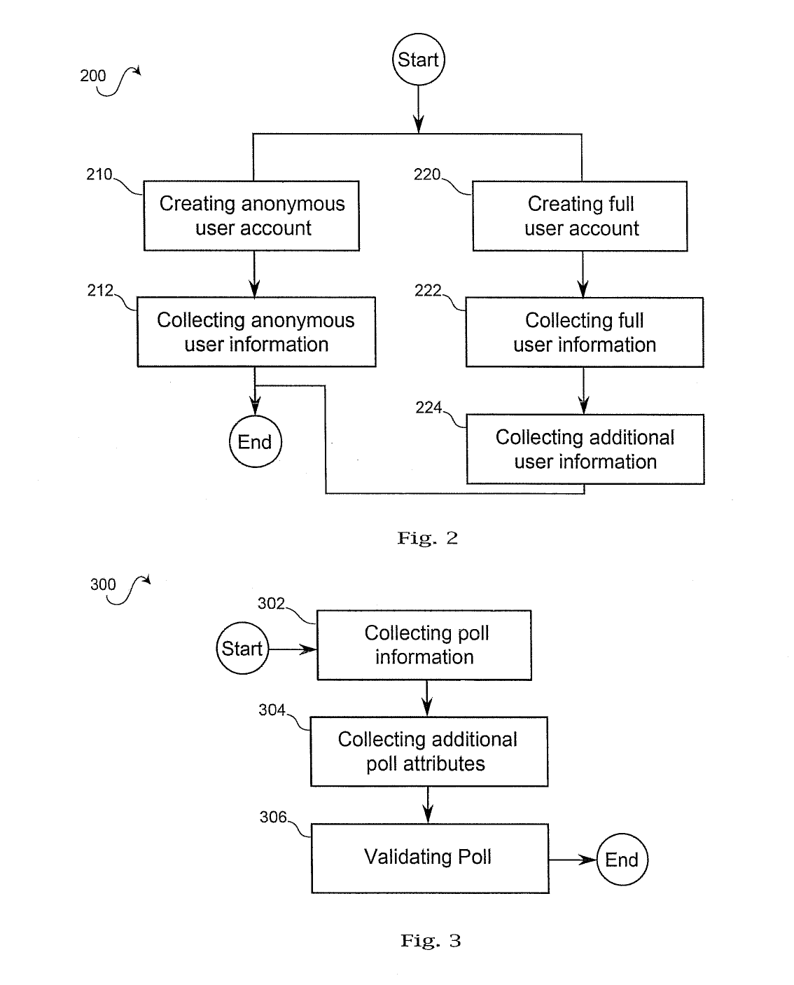

FIG. 2 shows an exemplary embodiment 200 of a method of registering a user account. The user account may be one of various types of user accounts, for example, an anonymous user account or a full user account. Anonymous user accounts and full user accounts may differ in the amount of information collected from the user, and in the rights afforded to the user. Alternatively, the user account may be a poll administrator account.

At step 210, a user may create an anonymous user account. At step 212, the server may collect anonymous user information, including locational information. Locational information may relate to a location within a hierarchical arrangement. For example, locational information may include information about the user's country and zip code, or the user's location inside a building, or a position within a corporate hierarchy, or any other locational information within a hierarchical arrangement. Messages displayed on one or various pages of the website may solicit the anonymous user to convert the anonymous user account to a full user account. Registering a user account may include allowing a user to complete a form on the website, or may include creating an account over the phone, over fax, over email, or using any account creation process known in the art.

Alternatively, at step 220, the user may create a full user account. At step 222, the server may collect full user information. For example, full user information may include a unique username and password, locational information, as well as required or optional information relating to the user's email and birth date. Locational information may relate to a location within a hierarchical arrangement. For example, locational information may include information about the user's country and zip code, or the user's location inside a building, or a position within a corporate hierarchy, or any other locational information within a hierarchical arrangement. Requiring that users register improves the quality of the polls by promoting the authenticity of the users.

In order to further improve the quality of the polls by promoting unique and genuine user accounts, registering a user may further include a reverse Turing test, such as a captcha or any other reverse Turing test known in the art, as well as an email confirmation step, and/or recording connection information such as an IP address.

Further, at step 224, the server may collect additional required or optional user information to create a user profile. Additional user information may include a picture, as well as information relating to the user's name, gender, educational background, computer skill level, political philosophy, religious philosophy, and any other characteristics that would be useful for filtering poll results. A user profile may avoid the redundancy and time inefficiency associated with having to provide identical user information for numerous polls. Additionally, user groups may be created, in order to create private polls. Alternatively, users may also avoid redundancy by importing user information from social media, such as social networking accounts or websites.

A user connection to a social media user profile may allow for the sharing of information with social networking groups on interesting polls, results, how group members voted, and comments. Further, this information may be leveraged to suggest polls to be viewed by the user. Alternatively a connection to social media may be used to find new groups with similar interests and opinions. Further, user profiles may display information gathered from votes, such as, for example, favorite poll categories, political inclination, comparison with other voters in their region or demographical category. The user profiles may become a place where user voting activities are summarized, analyzed and shared.

FIG. 3 shows an exemplary embodiment 300 of a method of facilitating the creation of a poll. At step 302, the server may collect required and optional information, such as a poll title, a poll question, and a set of answer choices. At step 304, the server may collect additional poll attributes, which may include a description, a set of keywords, a poll category, a poll subcategory, a set of keywords, a color scheme, a default topographical zoom level, a default poll zoom level, whether a response is required to view the poll, whether to include an option to abstain from participation, demographics restrictions, groups restrictions, a poll closing date and time, an option for whether answers are to be displayed in random order, a restart/regenerate poll setting, any external hyperlinks to additional information useful in answering the poll, a picture, and a video. The color scheme may include a color for each answer choice, as well as reserved colors for regions without votes and regions with tied votes. The poll creation step may be completed on the website using a form. The poll creation step may require user authentication, and/or good standing. Good standing may be determined based on user behavior, user asking and voting power, and level of site participation on the website. Potentially active poll question limits may be required and users may vote on whether a poll question should be added after it is validated.

At step 306, the poll may be validated. Poll validation may include checking for and/or correcting grammatical coherence, uniqueness and appropriateness of subject matter based on certain criteria, and may be done by the server, the user proposing the poll, or any other user or administrator.

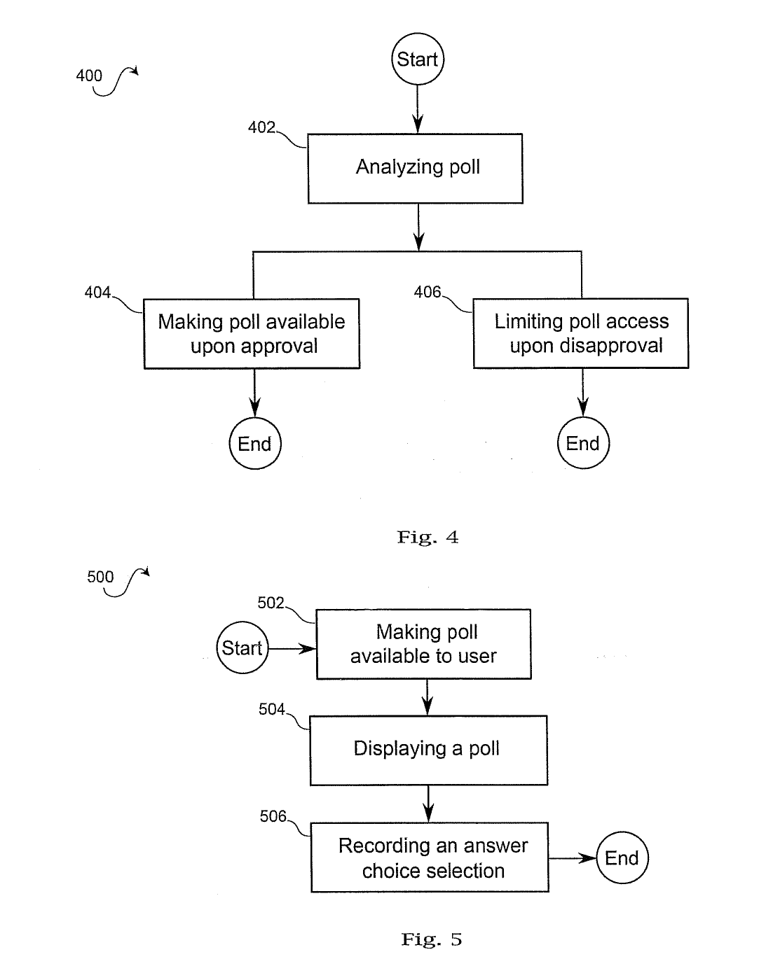

FIG. 4 shows an exemplary embodiment 400 of a method of facilitating a review of a poll. Poll review may be performed at an administrative end of the website, or alternatively at a server end or a client end of the website. In order to improve the quality of the polls, a poll may be analyzed at step 402, based on one or a series of criteria, such as subject matter and propriety of language. At step 404, a poll may be approved and made available for user participation. Alternatively, at step 406, a poll may be disapproved and its accessibility by other users may be limited. The creator of the poll may be notified in the event of any poll disapproval.

FIG. 5 shows an exemplary embodiment 500 of a method of facilitating participation in a poll. Poll participation may be performed at a client end. At step 502, a poll may be available to a user. Poll availability may depend on user and/or poll attributes. Polls may also be featured based on system criteria or randomly, and made available as popular or current based on activity in the poll. At step 504, the user may be presented with a poll question and a set of answers. At step 506, the user answer choice selection may be recorded. The poll participation step may be completed on the website. Alternatively, poll participation may be completed on a widget on another website—such as an embedded poll —, a mobile device, or on a social networking site. Alternatively, a user may search and view available polls based on search criteria.

In order to improve the quality of the poll, the answer choices may optionally be displayed in a random order, and/or may differ from one user session to another if appropriate. Further, a poll may or may not be available to given a user, depending on poll settings, poll status—such as whether or not the poll is closed—the location of the user, whether the user is logged in, the type of user account, or other attributes of the user. Furthermore, depending on poll settings, poll results may or may not be displayed while the user is participating. Further, embodiments of the system may be private and closed to the public. For example, polls may be available only to members of specified organizations.

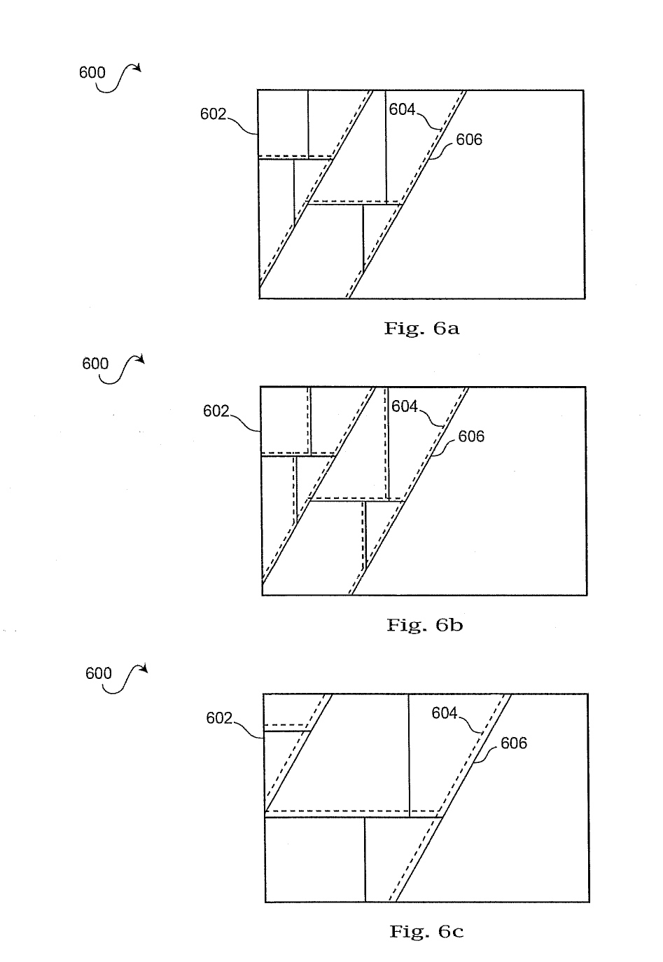

FIGS. 6a, 6b and 6c show an exemplary embodiment 600 of a system for displaying poll results. Poll results may be automatically displayed after participating in a poll. Alternatively, poll results may be accessed directly through the website, through a mobile device, through a widget on another website—such as an embedded poll —, or from a social networking site. Alternatively, a user may search and view available polls based on search criteria. Alternatively, a user may filter results according to various criteria, including user attributes, such as, for example, gender, educational background, computer skill level, political philosophy, religious philosophy, age, interests, ethnicity, personality traits, and profession, or topographical attributes, such as, for example, zip code, state, and country, or any other criteria. Filtering may help a user manage a large volume of polls and target the polls of interest. Users may request results of multiple polls in a custom report.

Poll results may be displayed on a map 602. The map may include a poll map 604 associated with a topographical map 606. A color legend may be displayed. Additional statistical information may be displayed. Alternatively, results may be displayed in a chart, such as a pie or graph chart.

Navigation of the map 602 may be performed using panning, topographical zooming and poll zooming. Each may have a default value, and may be changed by a viewing user. Panning, topographical zooming and poll zooming may be accomplished using various input methods, such as a mouse pointer, a touch screen, a scroller, and clickable links. Moreover, various shortcuts on the page may update any combination of panning, topographical zooming and poll zooming levels. Further, panning, topographical zooming and poll zooming may update other elements of the page, such as statistics and comments.

Panning may update the viewable area of the map 602, and may allow for displacing the map along any number of dimensions. A rotation option may also be available.

Topographical zooming may determine the zoom level of the topographical map 606. A default topographical zooming level may be a world poll zooming level (displaying all countries), a user-defined topographical zooming level, or any other topographical zooming level. For example, in the case of an non-geographical hierarchical arrangement, a default topographical zooming level may be company-wide, or building-wide, or any other topographical zooming level. Topography may include world topography, or any custom map, physical or abstract. Topographical zooming may be accomplished and rendered using any map zooming method known in the art.

The poll map 604 (represented by dashed lines) may overlay the topographical map 606 (represented by solid lines). The poll map 604 may be subdivided into a plurality of subdivisions according to a hierarchical arrangement. This hierarchical arrangement may be a set of child-parent relationships. Each subdivision may be associated with a region of the topographical map 606.

Poll zooming may update the subdivision level of the poll map 604. Each poll zooming level may be defined according to a set of subdivisions organized using a hierarchical arrangement. A default poll zooming level may be a user-defined zooming level, or any other poll zooming level. The poll zooming level may determine the scale at which the poll map 604 may be subdivided according to the hierarchical arrangement. Each subdivision may correspond to a region on the topographical map 606, which the poll map 604 may overlay. Each subdivision may be colored according to polling results in the region associated with each subdivision, and according to a color scheme associated with the poll. The color of each subdivision of the poll map may be associated with the answer choice selected by a majority of poll participants in the region with which that subdivision is associated.

Poll results may also be filtered using various criteria, automatically, or by a user. For example, poll results may be filtered to only include data from poll participants over the age of 17. Alternatively, criteria may relate to any combination of user attributes or information related to the account type of a user. Further, viewing poll results may be restricted according to user criteria or the account type of a user.

FIGS. 6a and 6b show the same topographical zooming level, but different poll zooming levels. FIGS. 6a and 6c show the same poll zooming level, but different topographical zooming levels. FIGS. 6b and 6c show different poll zooming levels, as well as different topographical zooming levels.

Users may comment on polls, track polls, as well as mark them as “favorites.” Comments may be associated with the region of the user and may only be visible when viewing that region or a parent region. They may also be filtered by other qualities of the commenter. Any filter applied to the map may be applied to the comments.

The website may be translated into multiple languages.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A computer-implemented polling method performed on a website, comprising:
registering a user account;
facilitating the creation of a poll;
facilitating a review of the poll;
facilitating user participation in the poll; and
facilitating viewing results of the poll.

2. The method of claim 1, wherein registering a user account comprises at least one of registering an anonymous user account, a full user account, and an administrator account.

3. The method of claim 2, wherein registering an anonymous user account comprises creating an anonymous user account and collecting anonymous user information, comprising anonymous locational information relating to a location within a hierarchical arrangement.

4. The method of claim 2, wherein registering an full user account comprises creating an full user account and collecting at least one of full user information and additional user information.

5. The method of claim 4, wherein the full user information comprises locational information relating to a location within a hierarchical arrangement, and at least one of a username, a user password, user email information, and user birth date information.

6. The method of claim 4, wherein the additional user information comprises at least one of a user picture, user name information, user gender information, user educational background information, user computer skill level information, user political philosophy information, and user religious philosophy information.

7. The method of claim 1, wherein registering a user account comprises at least one of a reverse Turing test, an email confirmation step, and recording connection information.

8. The method of claim 1, wherein facilitating the creation of a poll comprises collecting poll information and additional poll attributes.

9. The method of claim 8, wherein poll information comprises at least one of a poll title, a poll question, a poll description, and a set of poll answer choices.

10. The method of claim 8, wherein the additional poll attributes comprise at least one of a set of poll keywords, a poll category, a poll subcategory, a set of keywords, a poll color scheme, a default topographical zoom level, a default polling zoom level, whether a response is required to view the poll, whether to include an option to abstain from participation, poll demographics restrictions, poll groups restrictions, a poll closing date and time, an option for whether answers are to be displayed in random order, a restart/regenerate poll setting, an external hyperlink to additional information, a poll picture, and a poll video.

11. The method of claim 8, further comprising validating the poll, wherein validating the poll comprises at least one of verifying and correcting at least one of grammatical coherence, uniqueness and appropriateness of the poll.

12. The method of claim 1, wherein facilitating a review of the poll comprises at least one of analyzing the poll based on at least one criterion, and one of approving the poll or disapproving the poll,
wherein approving the poll comprises making the poll available for user participation, and
wherein disapproving the poll comprises limiting poll accessibility by users.

13. The method of claim 12, wherein the at least one criterion comprises at least one of subject matter and propriety of language.

14. The method of claim 1, wherein facilitating user participation in the poll comprises presenting a user with a poll question and a set of answers, and recording an answer selection by the user.

15. The method of claim 1, wherein facilitating user participation in the poll comprises facilitating a poll search by the user.

16. The method of claim 1, wherein facilitating viewing results of the poll comprises displaying the results of the poll on a map comprising a poll map associated with a topographical map.

17. The method of claim 16, wherein the poll map is navigable using at least one of:
panning comprising updating a viewable area of the map;
topographical zooming comprising updating a zoom level of the topographical map; and
poll zooming comprising updating a subdivision level of the poll map.

18. The method of claim 16, wherein a poll zooming level determines a scale at which the poll map is subdivided according to a hierarchical arrangement.

19. The method of claim 16,
wherein the poll map overlays the topographical map,
wherein the poll map is subdivided into a plurality of subdivisions according to a hierarchical arrangement,
wherein at least one subdivision is associated with at least one of a plurality of regions of the topographical map, and
wherein the at least one subdivision is colored according to polling results in the at least one region.

20. The method of claim 19, wherein a color of the at least one subdivision of the poll map is associated with an answer choice selected by a majority of poll participants in the at least one region with which the at least one subdivision is associated.
